(19) United States
(12) Patent Application Publication
(10) Pub. No.: US 2005/0149696 A1
(43) Pub. Date: Jul. 7, 2005

(54) Method and apparatus to control steering of instruction streams

(76) Inventors: Robert L. Hinton, Hillsboro, OR (US); Stephan J. Jourdan, Portland, OR (US); Alexandre J. Farcy, Hillsboro, OR (US)

Correspondence Address: KENYON & KENYON, 1500 K STREET, N.W., SUITE 700, WASHINGTON, DC, 20005, US

(21) Appl. No.: 10/745,526

(22) Filed: Dec. 29, 2003

(51) Int. Cl. G06F 9/30

(52) U.S. Cl. 712/204

(57) ABSTRACT

Rather than steering one macroinstruction at a time to decode logic in a processor, multiple macroinstructions may be steered at any given time. In one embodiment, a pointer calculation unit generates a pointer that assists in determining a stream of one or more macroinstructions that may be steered to decode logic in the processor.

### BACKGROUND OF THE INVENTION

The present invention relates to processor design. More particularly, the present invention relates to improving the steering of instructions to decoding logic in a processor.

In known computer architectures, instructions to be executed by a processor, are stored in main memory (e.g., Random Access Memory or RAM). These instructions can be retrieved and stored in an instruction cache as part of a processor for later execution. As is known in the art, a processor includes a variety of sub-modules, each adapted to carry out specific tasks. In one known processor, these sub-modules include the following: the instruction cache, an instruction fetch unit for fetching appropriate instructions from the instruction cache; decode logic that decodes the instruction into a final or intermediate format, microoperation logic that converts intermediate instructions into a final format for execution; and an execution unit that executes final format instructions (either from the decode logic in some examples or from the microoperation logic in others). Under operation of a clock, the execution unit of the processor system executes successive instructions that are presented to it.

The instructions that are stored in the instruction cache are often referred to as macroinstructions. When appropriately decoded, a macroinstruction can be converted into one or more microoperations (also referred to as uops or microinstructions). As part of a known decode operation, based on each cycle of a system clock, a steering device is provided that steers a macroinstruction to one or more of decode programmable logic arrays (PLAs). For example if a macroinstuction can be decoded into one, two, three, or four microoperations, then four such decode PLAs are provided for this decode operation.

With the system above, one macroinstruction is decoded each cycle. Improving processor efficiency and performance is a constant endeavor in the design of processors. Accordingly, there is a need to improve the operation of the decoding operation in a processor.

### BRIEF DESCRIPTION OF THE DRAWINGS

FIG. 1 is a general block diagram of a computer system including a processor constructed and operating according to an embodiment of the present invention.

FIG. 2 is a block diagram of an apparatus for transferring instructions to decode logic according to an embodiment of the present invention.

FIG. 3 is a flow diagram of a method for generating instruction pointers according to an embodiment of the present invention.

FIG. 4 is a block diagram showing examples of lines of different types of instructions and the types of pointers generated in the flow diagram of FIG. 3

FIG. 5 is a flow diagram showing the selection of one of the pointers generated in the flow diagram of FIG. 3.

### DETAILED DESCRIPTION

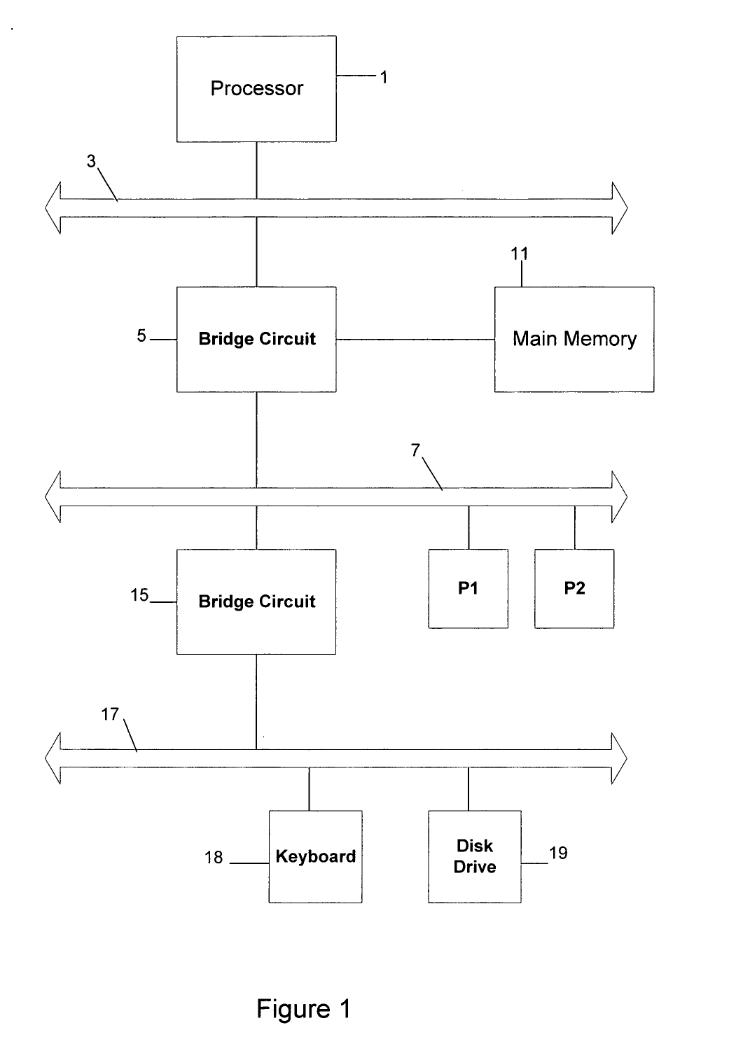

Referring to FIG. 1, a general block diagram is shown of a computer system including a processor constructed and operating according to an embodiment of the present invention. A processor 1 is coupled to a host bus 3 comprising signal lines for control, address, and data information. A first bridge circuit (also called a host bridge, host-to-PCI bridge, or North bridge circuit) 5 is coupled between the host bus and a Peripheral Component Interconnect (PCI) bus 7 comprising signal lines for control information and address/data information (see, e.g., PCI Specification, Version 2.2, PCI Special Interest Group, Portland, Oreg.). The bridge circuit 5 contains cache controller circuitry and main memory controller circuitry to control accesses to cache memory and main memory 11 (e.g., Dynamic Random Access Memory (DRAM)). Data from the main memory 11 can be transferred to/from the data lines of the host bus 3 and the address/data lines of the PCI bus 7 via the bridge circuit 5. A plurality of peripheral devices P1, P2, . . . are coupled to the PCI bus 7 that can be any of a variety of devices such as a LAN (Local Area Network) adapter, a graphics adapter, an audio peripheral device, etc. A second bridge circuit (also known as a South bridge) 15 is coupled between the PCI bus 7 and an expansion bus 17 such as an ISA (Industry Standard Architecture) bus. Coupled to the expansion bus are a plurality of peripheral devices such as a keyboard 18, a disk drive (e.g., a floppy disk drive) 19, etc.

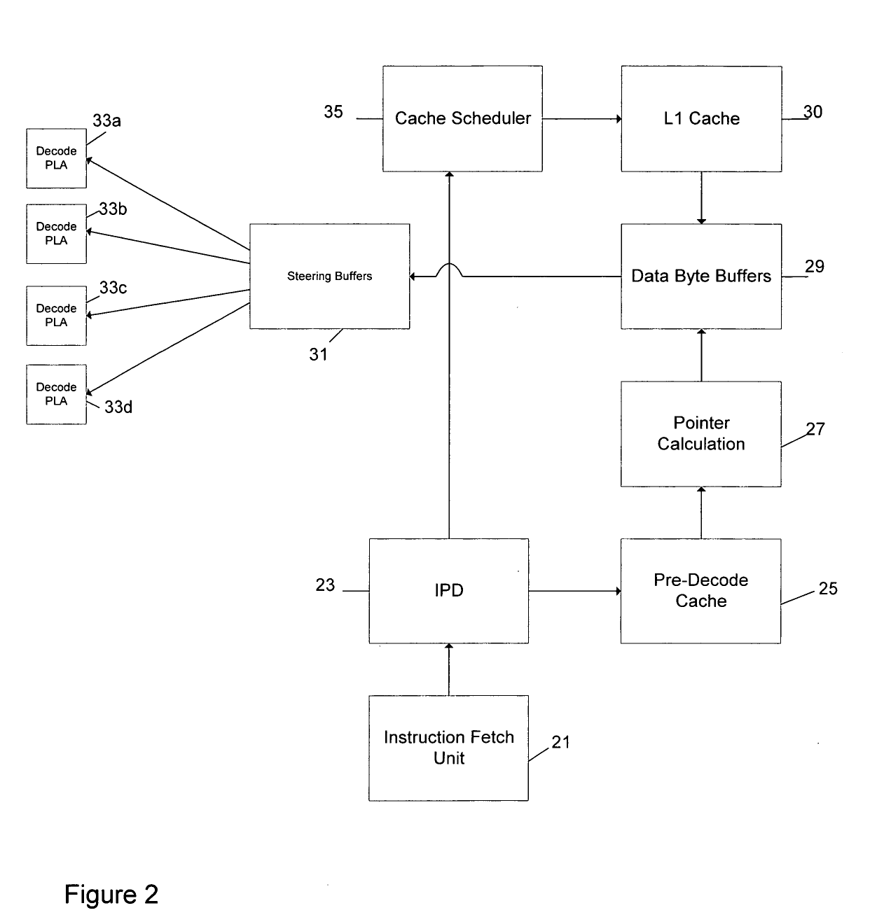

Macroinstructions retrieved from main memory 11 may be provided to processor 1. Referring to FIG. 2, a block diagram of a system within the processor 1 and constructed according to an embodiment of the present invention is shown. In this embodiment, macroinstructions (e.g., from memory 11) are provided by an instruction fetch unit (IFU) 21 to an Instruction Pre-Decode (IPD) unit 23. The IPD unit provides macroinstruction data to a cache scheduler 35 and control bytes associated with the macroinstrutcion data to a pre-decode cache 25. The macroinstruction and associated control data is processed in parallel before the macroinstructions are steered to decode logic (e.g., decode PLAs 33a-d) as described below.

In this embodiment, the control data includes information as to whether a byte is the first byte of a macroinstruction; whether a macroinstruction will decode into one or more than one microinstruction; and whether the byte includes prefix data (e.g., data relevant to how to decode the following instruction). The macroinstructions from the cache 30 are provided to the data byte buffers 29. The pointer calculation unit 27 provides control information to the data byte buffers 29. The macroinstructions and control information are provided to the steering buffers 31 that provide the appropirate macroinstruction(s) to the Decode PLAs 33a-d.

Certain types of programming applications can benefit greatly if more than one macroinstruction can be steered to the decode PLAs 33a-d per clock cycle. In this embodiment of the present invention, a “stream” is a series of anywhere from one to n macroinstructions. The value for n depends on the components provided in the processor. In this example, the value for n is 3. In this embodiment, stream steering comprises three operations. The first operation is to identify and mark the stream. Every byte of macroinstruction data is assumed to be the start of a stream, and based on the characteristics of that byte, a potential pointer to indicate the end of the stream is produced. In this embodiment, the end of stream pointer for a given byte is only used if that byte is in fact the beginning of a stream. The second operation is to separate the stream from the rest of the macroinstruction bytes. Though similar to operations performed in the steering of macroinstructions, instead of detecting the Beginning of Macro (BOM) instruction, the Beginning of Stream (BOS) is detected. The third operation is to separate the stream into individual macroinstructions and forwarding them to the correct decode logic.

To assist in a more efficient steering of macroinstructions, the macroinstructions, themselves, may be referred to as “fast steering” or “slow steering.” In this embodiment, a fast steering macroinstruction is one that decodes into a single microinstruction; a slow steering macroinstruction is one that decodes into more than one microinstruction. In this embodiment, a majority of macroinstructions decode to a single microinstruction (and are, thus, fast steering).

The predecode cache 25 provides control data for the macroinstructions to the pointer calculation unit 27. In this embodiment of the present invention, the pointer calculation unit generates a pointer based on the control data for the data byte buffers 29 and steering buffers 31 to control how macroinstructions are steered to the Decode PLAs 33a-d.

In the processor of this embodiment of the present invention, the average macroinstruction is between 3 and 4 bytes in length. Also, control data is associated with each byte or a multiple number of bytes in the macroinstruction data. In this embodiment, one bit of control data is provided for each byte of macroinstruction data that indicates (true/false) whether or not the byte in question is the beginning of a macroinstruction (BOM). Since the average macroinstruction is between three and four bytes in length, one bit of control data is provided for every four bytes of macroinstruction data to indicate whether all macroinstructions starting in those four bytes are macroinstructions that decode to single microinstructions. Other control data may be provided, such as to indicate whether the byte is a prefix byte. In this embodiment, if a byte is a prefix byte, then the macroinstruction is assumed to be a slow steering macroinstrution. The control data is provided to the PD (pre decode) cache 25, which in turn supplies it to the pointer calculation unit 27.

The pointer calculation unit 27 looks at the control data and for each byte of macroinstruction data, calculates and provides four pointers: 1. A pointer for the next BOM; 2. A pointer to the next slow steering BOM; 3. A pointer to the last BOM; 4. A pointer to the third fast steering BOM. The significance of these pointers will be described below. According to this embodiment of the present invention it is assumed that all bytes of a given macroinstruction belong to the same stream. In this embodiment, the largest macroinstruction to be executed by the processor is 15 bytes in length, so it is also assumed that a stream cannot contain more than 16 consecutive bytes. Accordingly, macroinstruction bytes are looked at in 16 byte “chunks.” Since most macroinstructions are longer than one byte, a macroinstruction stream can span across two consecutive chunks. In this embodiment, it is assumed that the last instruction of a taken block of macroinstructions is the end of a stream, and the target of a taken block of macroinstructions starts a stream. For macroinstructions that are predicted to be slow steering, such a macroinstruction starts and ends a stream. And, in this embodiment, a maximum of three fast steering macroinstructions may form a stream.

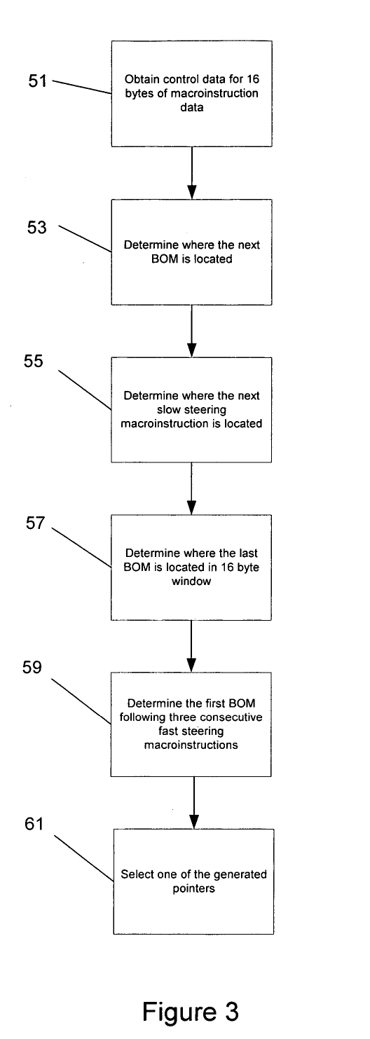

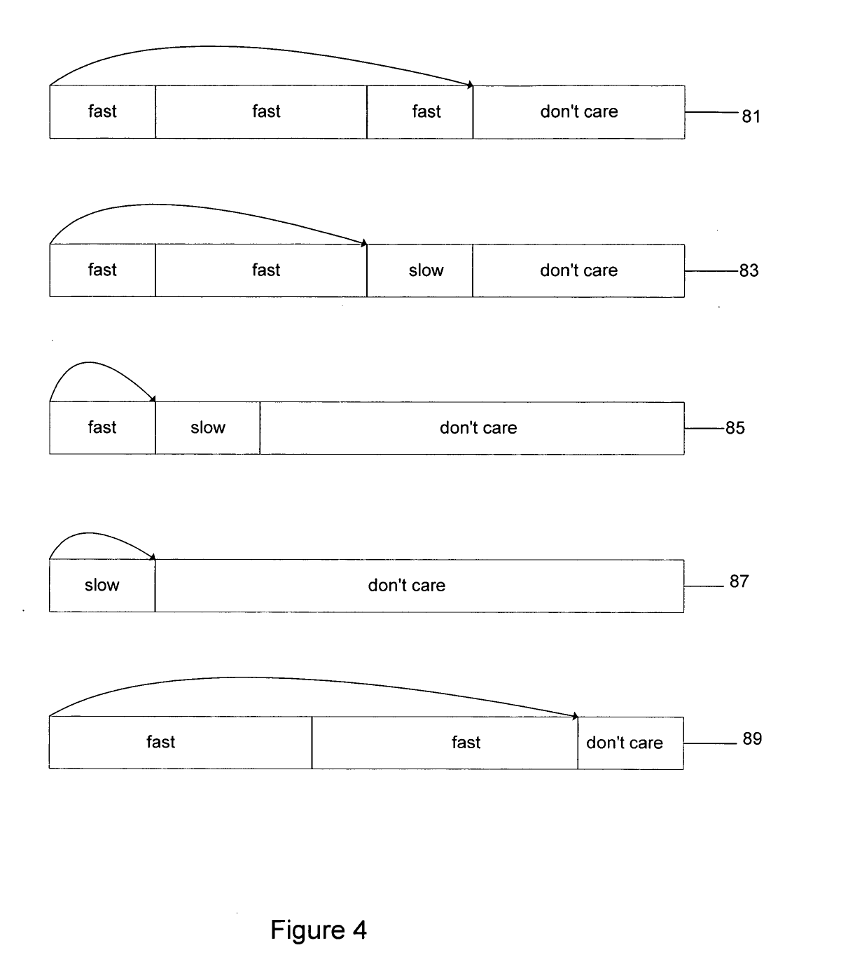

An example of the operation of the pointer calculation unit is shown in FIG. 3. In block 51, control data for one or two, consecutive sixteen bytes of macroinstruction data are obtained from the predecode cache 25. In block 53, it is determined where the next BOM is located. It is noted that instead of a BOM control bit, an End of Macroinstruction (EOM) bit may be provided to indicate the last byte of a macroinstruction. In such a case, the next byte would necessarily be the first byte of a macroinstruction, allowing for a simple conversion. Referring to FIG. 4, line 87 represents a number of consecutive macroinstructions. In this case, the first byte (labeled “slow” for slow steering macroinstruction) is the byte under consideration. The next BOM would be the first byte of the next macroinstruction (as indicated by the arrow in line 87). Whether the next macroinstruction is a slow steering or fast steering instruction is irrelevant for the determination of the next BOM and is labeled “don't care.” As part of determining the next BOM, pointer calculation unit can generate a four-bit binary pointer identifying the number of bytes following the location from the byte under consideration (or current byte) where the next BOM can be found. This may be referred to as a Next BOM pointer.

In block 55 of FIG. 3, it is determined where the next slow steering macroinstruction begins relative to the current byte. Referring to FIG. 4 and lines 83 and 85, the pointer would refer to the number of bytes from the current byte where the first byte of the next slow steering macroinstruction is located (Next Slow BOM pointer). In block 57 of FIG. 3, it is determined where the last BOM is located for the sixteen bytes under consideration. Referring to FIG. 4 and line 89, the pointer refers to the last BOM in the line (it is irrelevant whether that macroinstruction is slow steering or fast steering)(Last BOM pointer). In block 59 of FIG. 3, it is determined where the next BOM is located following a third consecutive fast steering macroinstruction. Referring to FIG. 4, and line 81, the pointer refers to the first byte of the next macroinstruction after three, consecutive fast steering macroinstructions (see line 81)(3^{rd} BOM).

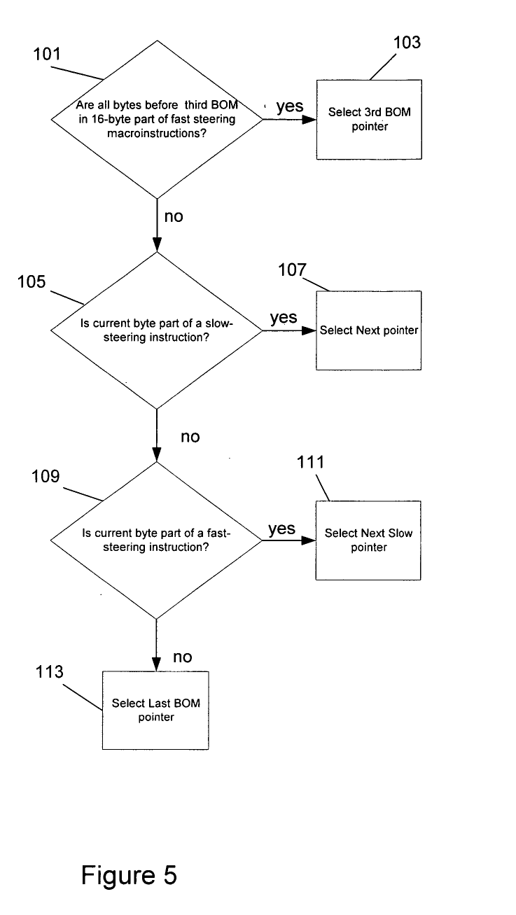

Referring back to FIG. 3, in block 61, one of the four pointers generated by the pointer calculation unit is selected. Referring to FIG. 5, a block diagram is shown of a circuit used to select an appropriate pointer according to an embodiment of the present invention. In this example, the four pointers as described above are provided to a multiplexer. For each valid byte of macroinstruction data, a pointer is selected based on, for example, the decision diagram of FIG. 5. In block 101, it is determined whether in the 16-byte block beginning with the current byte (i.e., the byte under consideration) all bytes previous to the third BOM (after the current byte) in the 16-byte block are part of fast-steering macroinstructions. If they are, then in block 103, the pointer for the three consecutive fast steering macroinstructions is selected (3^{rd} BOM). In block 105 it is determined whether the current byte is part of a slow steering macroinstruction (including prefix bytes). If it is, then in block 107, the Next BOM pointer is selected. If it is not, then in block 109, it is determined whether the current byte is part of a fast steering macroinstruction. If so, then the Next Slow BOM pointer is selected (block 111). If none of the previous three pointers are selected, then in block 113, the Last BOM pointer is selected. In this case, there are not enough bytes in the 16-byte block to select three instructions to be steered together.

Referring back to FIG. 2, the pointer calculation unit 27 provides the selected pointer to the data byte buffers 29. The data byte buffers supply the macroinstructions from the cache 30 and the selected pointers to the steering buffers 31. The steering buffers 31 then provide macroinstructions to the decode PLA devices as streams instead of one macroinstruction at a time. Thus, when the bytes of a first macroinstruction are provided to the steering buffers 31, the associated pointer is ascertained for the BOM byte. According to embodiments of the present invention, bytes for a single macroinstruction or multiple macroinstructions are provided to the decode PLAs 33a-c. In one embodiment, the selected pointer for a BOM byte determines how many macroinstructions are to be sent to the decode PLAs. For example, if the selected pointer for a BOM byte (i.e., the current byte) points to the third BOM, then the steering buffers will transfer the bytes from the current byte to the byte preceding the byte indicated by the 3^{rd} BOM pointer to the decode PLAs. In this case, the stream includes three macroinstructions that are being transferred, and each is macroinstruction is decoded into a single microinstruction. As another example, if the Last BOM pointer is associated with the current byte (being the BOM byte for a macroinstruction), then there is the potential (e.g., see line 89 in FIG. 4), that the stream will include two macroinstruction, where each decode into a single microinstruction. In other cases, the selected pointer will be such that the stream will include a single macroinstruction (either fast steering or slow steering) being transferred to the decode PLAs 33a-d.

In this embodiment, a pointer is provided for each byte of macroinstruction data. The pointers generated by the pointer calculation unit 27 may be done in three clock cycles depending on the operating frequency of the processor. During the first cycle, the Next BOM, Next Slow BOM, and Last BOM pointers are generated. In this embodiment, determining the 3^{rd} BOM pointer takes two clock cycles to complete. In the third clock cycle the appropriate pointer is selected. As processor operating frequency increases, more clock cycles may be needed to calculate and select the appropriate pointer. Though in this example, a pointer is generated for each valid byte of macroinstruction data, the steering buffers will ignore the pointer values unless needed to determine the next stream of macroinstructions to be sent to the decode PLAs.

Using embodiments of the present invention, a greater number of macroinstructions may be provided to the decoding units per clock cycle resulting in improved performance for the processor.

Other embodiments of the invention will be apparent to those skilled in the art from consideration of the specification and practice of the invention. Furthermore, certain terminology has been used for the purposes of descriptive clarity, and not to limit the present invention. The embodiments and preferred features described above should be considered exemplary, with the invention being defined by the appended claims.

For example, though the above embodiments refer to streams including one, two, or three macroinstructions, a greater number of macroinstructions may be included in the stream size. In some cases, the size of the decode logic (e.g., the number of decode PLAs) determines the maximum number of macroinstructions that may be handled at one time. Also, though macroinstructions are defined as fast steering and slow steering, these classifications are not intended to be exclusive in controlling the number of macroinstructions that can be steered to decode logic at a time.

1. A method, comprising:
providing a plurality of instructions during a single clock cycle to decode logic in a processor.

2. The method of claim 1 wherein said plurality of instructions are provided by steering buffers coupled to said decode logic.

3. The method of claim 2 further comprising:
generating a pointer identifying said plurality of instructions; and
transferring said pointer to said steering buffers.

4. A method comprising:
providing a plurality of instructions and control data for said instructions;
determining an instruction stream from said plurality of instructions from said control data; and
providing said instruction stream to decode logic.

5. The method of claim 4 wherein said instruction stream includes at least one macro instruction.

6. The method of claim 4 wherein said instructions are provided by an instruction fetch unit.

7. The method of claim 6 wherein said determining operation includes
generating a pointer in a pointer calculation unit based on said control data.

8. The method of claim 7 wherein said determining operation further includes
selecting a number of instructions for said instruction stream based on said pointer.

9. The method of claim 6 wherein said determining operation includes
generating a plurality of pointers in a pointer calculation unit; and
selecting one of said plurality of pointers based on said control data.

10. The method of claim 9 wherein said determining operation further includes
selecting a number of instructions for said instruction stream based on said pointer.

11. The method claim 8 wherein in said selecting operation, said instruction stream includes at least two instructions, each of which is to be decoded by said decode logic into a single microinstruction.

12. A processor comprising:
decode logic to receive a plurality of instructions during a single clock cycle.

13. The processor of claim 12 further comprising:
steering buffers coupled to said decode logic, said steering buffers to provide said plurality of instructions to said decode logic.

14. The processor of claim 13 further comprising:
a pointer calculation unit coupled to said steering buffers to generate a pointer identifying said plurality of instructions.

15. A processor comprising:
an instruction unit to provide a plurality of instructions and control data for said instructions;
a pointer calculation unit coupled to said instruction unit to determine an instruction stream from said plurality of instructions from said control data;
steering buffers coupled to said instruction unit and said pointer calculation unit to transfer said instruction stream; and
decode logic coupled to said steering buffers to receive said instruction stream from said steering buffers.

16. The processor of claim 15 wherein said instruction stream includes at least one macroinstruction.

17. The processor of claim 15 wherein said instruction unit includes an instruction fetch unit.

18. The processor of claim 17 wherein said pointer calculation unit is to generate a pointer in based on said control data.

19. The processor of claim 18 wherein said pointer calculation unit is to select a number of instructions for said instruction stream based on said pointer.

20. The processor of claim 17 wherein said pointer calculation unit is to generate a plurality of pointers and select one of said plurality of pointers based on said control data.

21. The processor of claim 20 wherein said steering buffers are to select a number of instructions for said instruction stream based on said pointer.

22. The processor of claim 21 wherein said instruction stream includes at least two instructions, each of which is to be decoded by said decode logic into a single microinstruction.

23. The processor of claim 18 wherein said pointer calculation unit generates a plurality of pointers.

24. The processor of claim 23 wherein said plurality of pointer indicate at least one of the following: a location of the next beginning byte of a macroinstruction, a location of the next macroinstruction that when decoded includes two or more microinstructions, and a location of the first byte of a macroinstruction that follows three consecutive macroinstructions that when decoded include only one microinstruction.

25. A computer system comprising:
a Dynamic Random Access Memory to store a plurality of macroinstructions to be executed by a processor;
a processor coupled to said memory including
steering buffers to transmit an instruction stream including two or more macroinstructions; and
decode logic to receive said instruction stream from said steering buffers during a single clock cycle.

26. The system of claim 25 wherein said processor further includes
an instruction unit to provide a plurality of macroinstructions and control data for said macroinstructions; and
a pointer calculation unit coupled to said instruction unit to determine said instruction stream from said plurality of instructions from said control data;

24. The system of claim 26 wherein said instruction stream includes two or more macroinstructions, each of which is to be decoded into a single microinstruction.
